(19) United States
(12) Patent Application Publication
(10) Pub. No.: US 2022/0417281 A1
(43) Pub. Date: Dec. 29, 2022

(54) COMPUTER SYSTEM, AND METHOD AND PROGRAM FOR MONITORING IOT DEVICE

(71) Applicant: OPTIM CORPORATION, Saga (JP)

(72) Inventor: Shunji SUGAYA, Tokyo (JP)

(21) Appl. No.: 17/270,621

(22) PCT Filed: Jun. 29, 2018
(86) PCT No.: PCT/JP2018/024760

§ 371 Date: Mar. 30, 2021

(51) Int. Cl. H04L 9/40

(52) U.S. Cl. CPC H04L 63/1466; H04L 63/0236; H04L 63/083

(57) ABSTRACT

Provided are a computer system, a method and a program for monitoring an IoT device that improve the security. The computer system that monitors a connected IoT device 100 monitors the login state of the IoT device 100, detects unauthorized access based on the result of the monitoring, learns at least one of an ID and a password for the unauthorized access, judges whether at least one of an ID and a password that are previously stored for the IoT device 100 are easily decrypted by access to the IoT device, and controls the access to an IoT device for the judgment in a predetermined priority order.

### TECHNICAL FIELD

The present disclosure relates to a computer system, a method and a program for monitoring an IoT device that monitor a connected IoT.

### BACKGROUND

Recently, the number of Internet of things (hereinafter referred to as “IoT”) devices connected with local area networks (hereinafter referred to as “LANs”) has increased. The user can log in an IoT device and use various functions of the IoT device by inputting the ID or the password to a predetermined terminal.

There has been a problem for the user when another user gains unauthorized access to the IoT device and uses it.

A system that prevents such unauthorized access, for example, previously creates action planning information and, if the location information of the monitored device is not corresponding to this action planning information, locks the device to make unusable for the abuser even after the password is leaked is disclosed.

### DOCUMENT IN THE EXISTING ART

### Patent Document

Patent Document 1: JP2010-220017A

### SUMMARY

However, the composition of Patent Document 1 copes with the problem after the password of the IoT device is leaked but is never able to judge if the password is easily decrypted. Additionally, the composition consumes too much time to sequentially check all the IoT devices to judge if any device is abused because the number of the IoT devices that one user owns has increased recently.

An objective of the present disclosure is to provide a computer system, a method and a program for monitoring an IoT device that preferentially check a high-risk IoT device to improve the security.

The present disclosure provides a computer system configured to monitor a connected IoT device, including:

a monitoring unit configured to monitor a login state of the IoT device;

a detection unit configured to detect unauthorized access based on a result of the monitoring;

a learning unit configured to learn at least one of an ID or a password for the unauthorized access;

a judgment unit configured to judge whether at least one of an ID or a password that are previously stored for the IoT device are easily decrypted by access to the IoT device; and

a priority access unit configured to control the access to an IoT device for the judgment in a predetermined priority order.

According to the present disclosure, the computer system that monitors a connected IoT device monitors the login state of the IoT device, detects unauthorized access based on the result of the monitoring, learns at least one of an ID and a password for the unauthorized access, judges whether at least one of an ID and a password that are previously stored for the IoT device are easily decrypted by access to the IoT device, and controls the access to an IoT device for the judgment in a predetermined priority order.

The present disclosure is the category of a computer system, but the categories of a method, a program, etc. for monitoring an IoT device have similar functions and effects.

The present disclosure can provide a computer system, a method and a program for monitoring an IoT device that improve the security.

### BRIEF DESCRIPTION OF DRAWINGS

FIG. 1 is a schematic diagram illustrating the system for monitoring an IoT device 1.

FIG. 2 is an overall configuration diagram of the system for monitoring an IoT device 1.

FIG. 3 is the functional block diagram of the computer 10 and the IoT device 100.

FIG. 4 is a flow chart illustrating the IoT device monitoring process performed by the computer 10 and the IoT device 100.

FIG. 5 is a flow chart illustrating the IoT device login process performed by the IoT device 100.

FIG. 6 shows one example of the addition notification screen.

FIG. 7 shows one example of the first input screen.

FIG. 8 shows an example of the second input screen.

### DETAILED DESCRIPTION

Embodiments of the present disclosure will be described below with reference to the attached drawings. However, this is illustrative only, and the technological scope of the present disclosure is not limited thereto.

### Overview of System for Monitoring an IoT Device 1

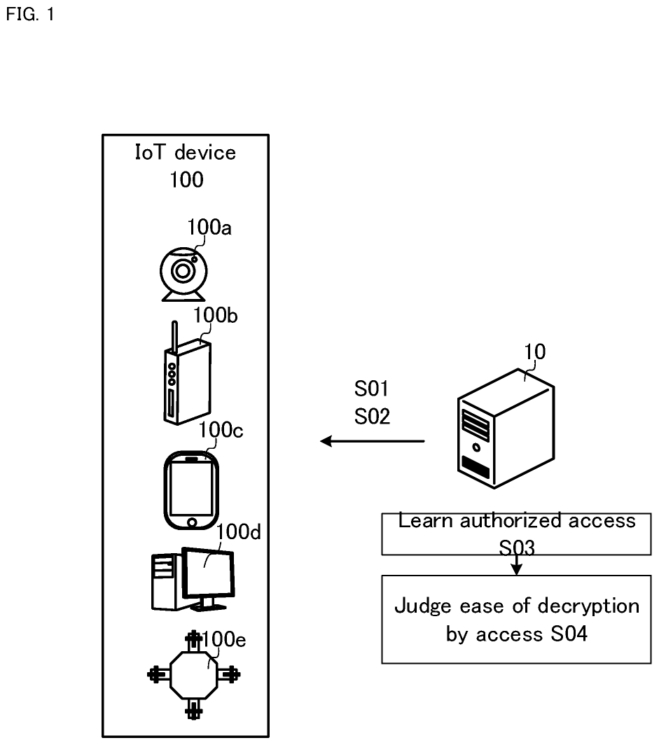

A preferable embodiment of the present disclosure is described below with reference to FIG. 1. FIG. 1 shows an overview of the system for monitoring an IoT device 1 according to a preferable embodiment of the present disclosure. The system for monitoring an IoT device 1 includes a computer 10 and IoT devices 100 (a network camera 100a, a sensor device 100b, a mobile terminal 100c, a computer device 100d, and a drone 100e), which is a computer system that monitors the IoT devices 100 connected with the computer 10.

In FIG. 1, the numbers of the computer 10 and the IoT devices 100 can be appropriately changed. The types of the IoT devices 100 can also be appropriately changed. Furthermore, the computer 10 and the IoT devices 100 are not limited to actual devices and may be virtual devices. The processes described later may be achieved by any one of or in combination of any two or more of the computer 10 and the IoT devices 100.

The computer 10 is a computer device data-communicatively connected with the IoT devices 100. The computer 10 may be a network device such as a router that connects the IoT devices 100 through a LAN.

The IoT devices 100 are terminal devices data-communicatively connected with the computer 10. Examples of the IoT devices 100 include a network camera 100a that takes an image such as a still or a moving image, a sensor device 100b that acquires environmental data such as spatial data and temporal data including sunlight, temperature, and wind power, a mobile terminal 100c and a computer device 100d that are electrical appliances such as a mobile phone, a mobile information terminal, a tablet terminal, a personal computer, a net book terminal, a slate terminal, an electronic book terminal, and a portable music player, and a drone 100e such as an uninhabited airborne vehicle or an uninhabited moving vehicle.

The computer 10 monitors the login state of an IoT device 100 (Step S01). In the login state, at least one of an ID and a password have been decrypted.

The computer 10 detects unauthorized access based on the result of the monitoring (Step S02). In the unauthorized access, at least one of the ID and the password have been decrypted since the ID or the password was mistyped in the past within predetermined times (e.g., 3 times) but input more than predetermined times.

The computer 10 learns at least one of the ID and the password for the detected unauthorized access (Step S03). For example, the computer 10 learns at least one of the ID and the password frequently used for unauthorized access as teacher data and also learns at least one of the ID and the password used for unauthorized access this time.

The computer 10 judges whether at least one of the ID and the password that are 100 previously stored for an IoT device 100 different from the IoT device 100 that has received unauthorized access this time are easily decrypted by access to the different IoT device 100 (Step S04). For example, the computer 10 attempts an access to the different IoT device 100 by using the ID or the password that is the same as or similar to that of the above-mentioned teacher data. If login is made by the ID or the password, the computer 10 judges that the previously stored ID 105 or password is easily decrypted. If login is not made by this ID or password, the computer 10 judges that the previously stored ID or password is hardly decrypted.

The computer 10 controls the access to IoT devices 100 to perform the judgment in a predetermined priority order. For example, for the predetermined priority order, the priority of an IoT device receiving more accesses from outside is raised, and the priority of other IoT 110 device receiving fewer accesses is lowered. The computer 10 also raises the priority of the detected IoT device 100 that has accessed from a non-memorized IP address.

### System Configuration of System for Monitoring an IoT Device 1

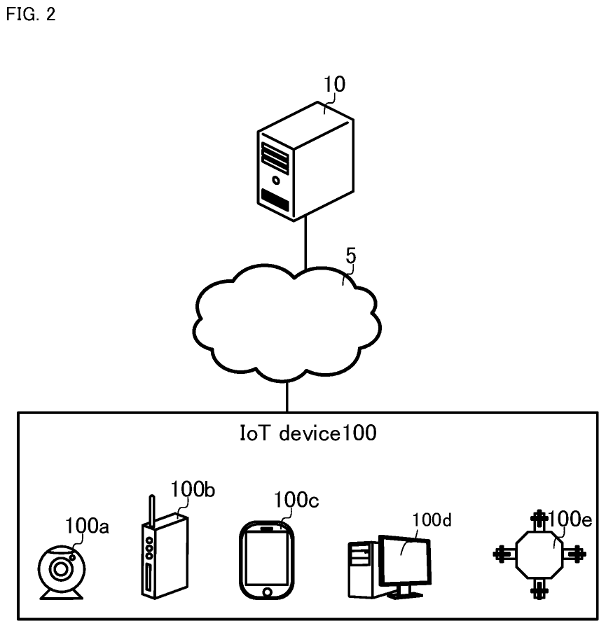

A system configuration of the system for monitoring an IoT device 1 according to a preferable embodiment is described below with reference to FIG. 2. FIG. 2 is a block diagram 115 illustrating the system for monitoring an IoT device 1 according to a preferable embodiment of the present disclosure. The system for monitoring an IoT device 1 includes a computer 10 and IoT devices 100 (a network camera 100a, a sensor device 100b, a mobile terminal 100c, a computer device 100d, and a drone 100e), and a public line network (e.g., the Internet network, the third and the fourth generation communication networks), which is a computer system that monitors the IoT devices 100 connected with the computer 10.

The number and the type of devices that compose the system for monitoring an IoT device 1 can be appropriately changed. The system for monitoring an IoT device 1 may not include actual devices and may be achieved with virtual devices. The processes to be described later may be achieved by any one of or in combination of any two or more of the devices that compose the system for monitoring an IoT device 1. The computer 10 may by a network device such as a router that connects the IoT devices 100 through a LAN.

The computer 10 is the above-mentioned computer device with the functions to be described later.

The IoT device 100 is the above-mentioned terminal device with the functions to be described later.

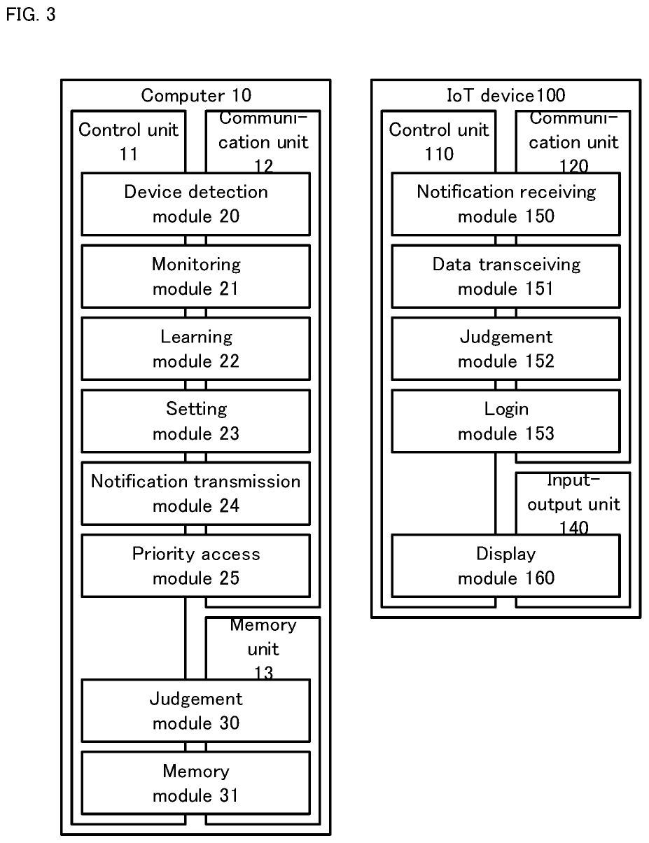

Functions: The functions of the system for monitoring an IoT device 1 according to a preferable embodiment are described below with reference to FIG. 3. FIG. 3 is the functional block diagram of the computer 10 and the IoT device 100.

The computer 10 includes a control unit 11 provided with a central processing unit (hereinafter referred to as “CPU”), a random access memory (hereinafter referred to as “RAM”), and a read only memory (hereinafter referred to as “ROM”); and a communication unit 12 such as a device that is capable to communicate with other devices, for example, a Wireless Fidelity or Wi-Fi® enabled device complying with IEEE 802.11. The computer 10 also includes a memory unit 13 such as a hard disk, a semiconductor memory, a record medium, or a memory card to store data.

In the computer 10, the control unit 11 reads a predetermined program to achieve a device detection module 20, a monitoring module 21, a learning module 22, a setting module 23, a notification transmission module 24, and a priority access module 25 in cooperation with the communication unit 12. Furthermore, in the computer 10, the control unit 11 reads a predetermined program to achieve a judgment module 30 and a memory module 31 in cooperation with the memory unit 13.

The IoT device 100 includes a control unit 110 including a CPU, a RAM, and a ROM; and a communication unit 120 such as a Wi-Fi® enabled device that is capable to communicate with other devices, in the same way as the computer 10. The IoT device 100 also includes various devices such as a display unit that outputs and displays data and images processed by the control unit 110, an input unit such as a touch panel, a keyboard, or a mouse that receives an input from the user as an input-output unit 140, and an imaging unit that takes an image such as a moving or a still image.

In the IoT device 100, the control unit 110 reads a predetermined program to run a notification receiving module 150, a data transceiving module 151, a judgment module 152, and a login module 153 in cooperation with the communication unit 120. In the IoT device 100, the control unit 110 reads a predetermined program to achieve a display module 160 in cooperation with the input-output unit 140.

### IoT Device Monitoring Process

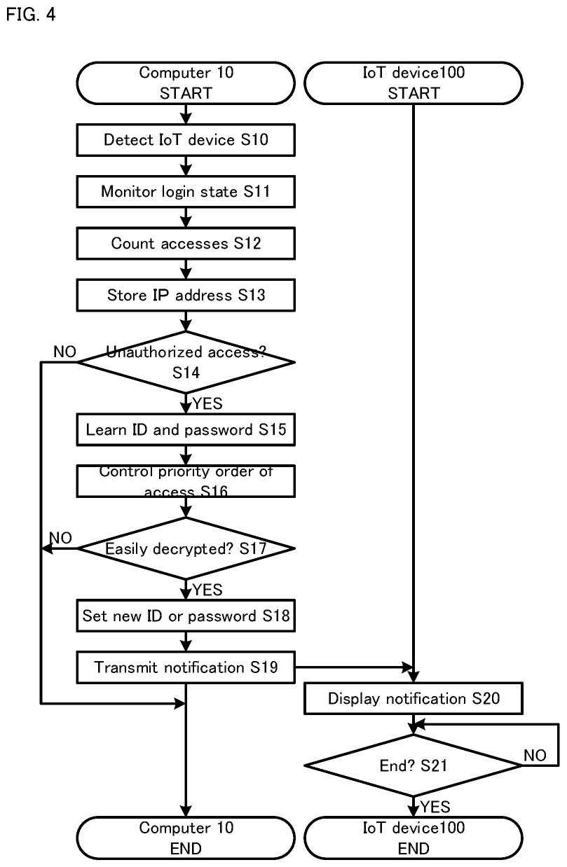

The IoT device monitoring process performed by the system for monitoring an IoT device 1 is described below with reference to FIG. 4. FIG. 4 is a flow chart illustrating the IoT device monitoring process performed by the computer 10 and the IoT device 100. The tasks executed by the modules of each of the above-mentioned devices will be explained below together with this process.

The device detection module 20 detects an IoT device 100 connected with the computer 10 (Step S10). In the step S10, the device detection module 20 detects an IoT device 100 connected to the computer 10 through a LAN or WAN. In this embodiment, the device detection module 20 detects a network camera 100a, a sensor device 100b, a mobile terminal 100c, a computer device 100d, and a drone 100e as IoT devices 100.

The monitoring module 21 monitors the login state of the detected IoT device 100 (Step S11). In the login state in Step S11, at least one of the ID and the password of the IoT device 100 have been decrypted. The monitoring module 21 monitors whether or not the IoT device 100 is in the login state.

The monitoring module 21 counts the number of times when the IoT device 100 is accessed from outside (Step S12). In Step S12, the monitoring module 21 simply counts the number of times when the IoT device 100 is accessed from external IP addresses as the number of accesses.

The monitoring module 21 has the memory module 31 store the IP addresses that accessed the IoT device 100 (Step S13).

The monitoring module 21 judges whether unauthorized access is detected based on the monitoring result (Step S14). In Step S14, the monitoring module 21 detects unauthorized access if at least one of the ID and the password have been decrypted since the IoT device 100 received the input of an ID or a password more than the times of mistyping any one of or the both of the ID and the password that were received in the past. For example, the monitoring module 21 detects unauthorized access if at least one of the ID and the password have been decrypted since the ID or the password that was received in the past was mistyped within predetermined times (e.g., 3 times) but receives input of the ID or the password more than 3 times, for example, 5 times.

The monitoring module 21 may detect unauthorized access in other ways. For example, the monitoring module 21 may detect unauthorized access, if the IoT device 100 is logged in from login information different from the typical login information, for example, if the IoT device 100 is logged in from location information different from the location information from which the IoT device 100 is typically logged in, if the IoT device 100 is logged in at a time different from the time when the IoT device 100 is typically logged in, if the IoT device 100 is logged in from at a terminal different from the terminal from which the IoT device 100 is typically logged in.

In Step S14, if unauthorized access is not detected (Step S14, NO), the monitoring module 21 ends this process.

On the other hand, in Step S14, if unauthorized access is detected (Step S14, YES), the learning module 22 learns at least one of the ID and the password for the detected unauthorized access (Step S15). In Step S15, the learning module 22 learns at least one of the ID and the password frequently used for unauthorized access and at least one of the ID and the password used for unauthorized access this time as teacher data. Examples of the ID or the password frequently used for unauthorized access include the default ID or password (e.g., “admin”, “user”); the same ID or password for more than one IoT devices; an ID or a password consisting of same character strings (e.g., “0000”, “1111”, “AAAA”); an ID or a password consisting of consecutive alphanumeric characters (e.g., “1234”, “5678”, “ABCD”, “abc123”); an ID or a password not consisting of the combination of upper case characters, lower case characters, alphanumeric characters, and signs; an ID or a password consisting of the characters input just as the keyboard layout (e.g., “qwerty”, “poiuy”); an ID or a password consisting of only a simple name (e.g., “yamada”, “satou”); and an ID or a password consisting of a simple term in a dictionary (e.g., “apple”, “sample”).

The priority access module 25 controls the priority order of access to IoT devices 100 (Step S16). In Step S16, the priority access module 25 controls the access to an IoT device 100 based on a predetermined priority order to judge if the ID or the password is easily decrypted.

The priority access module 25 determines the priority order based on the number of accesses counted in the process of the above-mentioned step S12. For example, the priority access module 25 determines the priority order of IoT devices 100 in order from the largest number of accesses. As the result, the priority access module 25 controls the priority order to raise the priority of the IoT device 100 that receives more accesses and access this IoT device 100. The judgement module 30 sequentially accesses to a target IoT device 100 based on the control result.

Alternatively, the priority access module 25 determines the priority order based on a new address different from those stored in the process of the above-mentioned step S13. For example, if the IoT device 100 is accessed from a new IP address, the priority access module 25 controls the priority order to raise the priority of the IoT device 100 and access this IoT device 100. The priority access module 25 may determine the priority order in order from the largest number of such new IP addresses or may raise the priority by one step whenever a new IP address is detected.

The priority access module 25 may combine the above-mentioned two methods to determine the priority order. For example, the priority access module 25 raises the priority of an IoT device 100 detecting more accesses and a new IP address and determines the priority order of an IoT device 100 receiving less accesses but detecting a new IP address to follow. The priority access module 25 may also appropriately determine the priority order based on the combination.

The judgment module 30 judges whether at least one of an ID and a password that are previously stored in the memory module 31 for an IoT device different from the IoT device 100 that received unauthorized access has been detected this time are easily decrypted by access to the different IoT device 100 (Step S17). In Step S17, the judgment module 30 attempts to access the different IoT device 100 based on the learned teacher data. As the result, the judgment module 30 judges that the previously stored ID or password is easily decrypted if the different IoT device 100 is logged in and also judges that the previously stored ID or password is hardly decrypted if the different IoT device 100 is not logged in. The judgment module 30 repeats the access several times to perform the judgment. The judgment module 30 determines the order of access to IoT devices 100 based on the priority order determined in the process of the above-mentioned step S16 and attempts accesses based on this order of access.

In Step S17, if the previously stored ID or password is hardly decrypted (Step S17, NO), the judgment module 30 ends this process. If the judgment module 30 judges that the previously stored ID or password is hardly decrypted, the judgment module 30 may transmit a notification to a terminal owned by the user, a mobile terminal 100c, and a computer device 100d. The terminal owned by the user, the mobile terminal 100c, and the computer device 100d may display the notification.

On the other hand, in Step S17, if the judgment module 30 judges that the previously stored ID or password is easily decrypted (Step S17, YES), the setting module 23 sets a new ID or password for the IoT device 100 besides the ID or the password of the IoT device 100 stored in the memory module 31 (Step S18). In Step S18, the setting module 23 sets a new ID or password in addition to the stored ID or password. In an embodiment, two ID or passwords are set for the IoT device 100. The setting module 23 sets an ID or a password that hardly matches to the above-mentioned ID or password frequently used for unauthorized access. In addition, the setting module 23 sets an ID or a password, considering convenience for the user. For example, the setting module 23 inserts alphanumeric characters in a part of or before and after the original ID or password or combines these insertions to set an ID or a password that hardly matches to the ID or the password frequently used for unauthorized access. For example, if the original ID is “yamada”, the setting module 23 sets “01yama02da” as a new ID. Likewise, if the original password is “tarou”, the setting module 23 sets “ta05r12ou” as a new password.

The ID or the password that the setting module 23 sets is not limited to the above-mentioned examples and can be appropriately changed.

The notification transmission module 24 transmits the notification indicating that a new ID or password has been set for the IoT device 100 (Step S19). In Step S19, the notification is transmitted to a mobile terminal 100c or a computer device 100d with a display unit, an input-output unit, etc., as an IoT device 100. The notification transmission module 24 may transmit the notification to a terminal device, etc., owned by other users.

The notification receiving module 150 receives the notification. The display module 160 displays an addition notification screen based on the notification (Step S20).

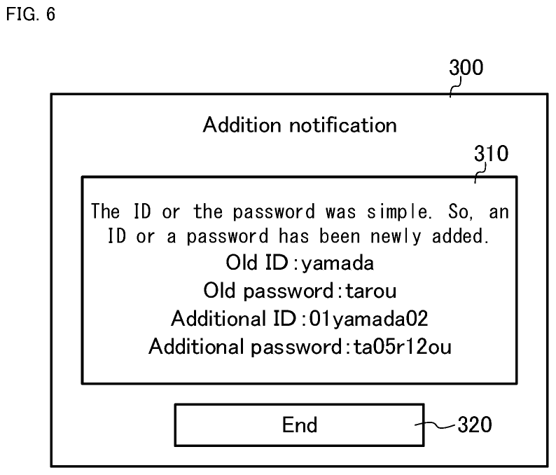

The addition notification screen that the display module 160 displays is described below with reference to FIG. 6. FIG. 6 shows one example of the addition notification screen. The display module 160 displays an addition display area 310 and an end icon 320. The addition display area 310 displays the reason why an ID or a password has been added, the ID or the password before the addition, and the ID or the password after the addition. The display module 160 displays “The ID or the password was simple. Therefore, an ID or a password has been newly added.” as a reason for the addition. The display module 160 displays a reason for the addition to explain that the above-mentioned ID or password is frequently used for unauthorized access. The display module 160 displays “Old ID: yamada” as the ID before the addition and “Old password: tarou” as the password before the addition. The display module 160 displays “01yamada02” as the ID after the addition and “ta05r12ou” as the password after the addition. The end icon 320 closes the screen by receiving an input from the user.

The display module 160 judges whether the display module 160 has received an input to close the addition notification screen (Step S21). In Step S21, if the display module 160 judges that the display module 160 has not received the input (Step S21, NO), specifically an input from the end icon 320, the display module 160 repeats the process.

On the other hand, in Step S21, if the display module 160 judges that the display module 160 has received the input (Step S21, YES), specifically an input from the end icon 320, the display module 160 ends the process.

### IoT Device Login Process

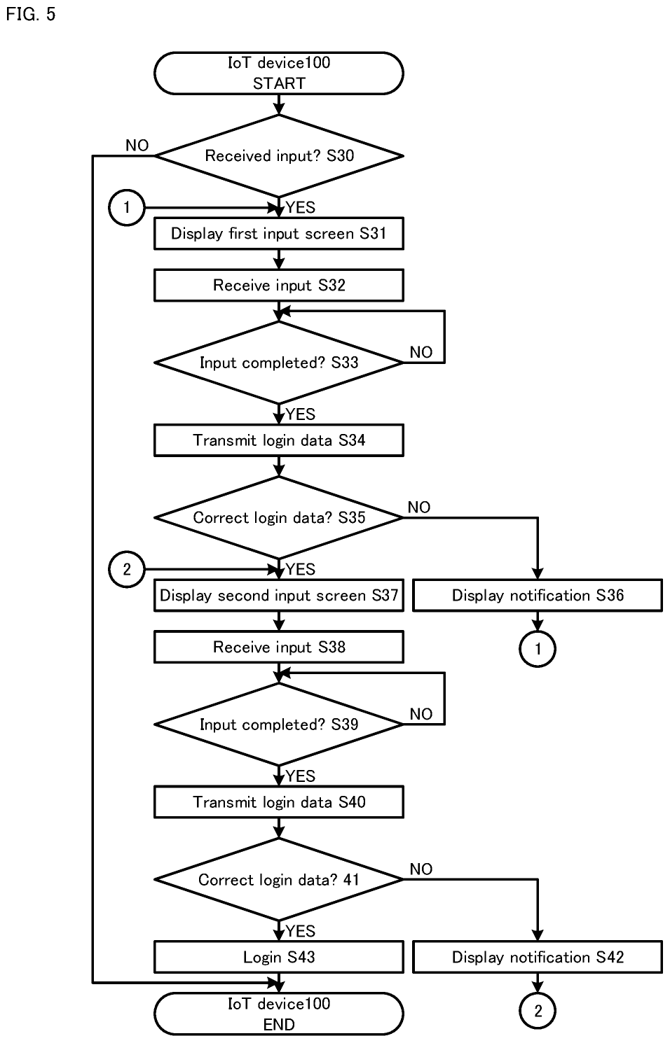

The IoT device login process performed by the system for monitoring an IoT device 1 is described below with reference to FIG. 5. FIG. 5 is a flow chart illustrating the IoT login process performed by an IoT device 100. The tasks executed by the modules are described below with this process.

The display module 160 judges whether the display module 160 has received an input to log in the IoT device 100 (Step S30). In Step S30, the display module 160 runs a special application, a web browser, etc., to receive an input to log in the IoT device 100.

In Step S30, if the display module 160 judges that the display module 160 has not received the input (Step S30, NO), the display module 160 ends the process.

On the other hand, in Step S30, if the display module 160 judges that the display module 160 has received the input (Step S30, YES), the display module 160 displays the first input screen (Step S31).

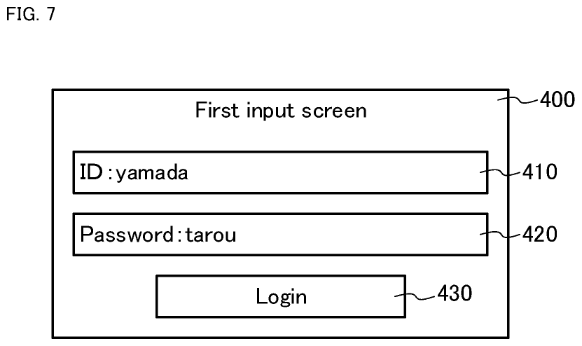

The first input screen that the display module 160 displays is described below with reference to FIG. 7. FIG. 7 shows an example of the first input screen. The display module 160 displays an ID input area 410, a password input area 420, and a login icon 430 in the first input screen 400. The ID input area 410 receives an ID input from the user. The password input area 420 receives a password input from the user. The ID input area 410 and the password input area 420 may display a virtual keyboard and receive the input from the user through this virtual keyboard or speech input, etc. The login icon 430 receives the input from the user. The data transceiving module 151 transmits the received ID or password to the target IoT device 100 as the login data.

The display module 160 receives an input of the ID or the password. (Step S32). In Step S32, the display module 160 receives an input of the original ID or the password. In an embodiment, the display module 160 receives an input of “yamada” as the ID and “tarou” as the password.

The display module 160 judges whether the input has been completed (Step S33). In Step S33, the display module 160 judges whether the display module 160 has received an input from the login icon 430.

In Step S33, if the display module 160 judges that the input has not been completed (Step S33, NO), specifically if the display module 160 has not received an input from the login icon 430, the display module 160 repeats the process.

On the other hand, in Step S33, if the display module 160 judges that the input has been completed (Step S33, YES), specifically if the display module 160 has received an input from the login icon 430, the data transceiving module 151 transmits the received ID or password to the target IoT device 100 as the login data (Step S34).

The data transceiving module 151 receives the login data. The judgment module 152 judges whether the received login data is correct (Step S35). In Step S35, the judgment module 152 judges whether the ID and the password contained in the login data are correct. If the login data is not correct (Step S35 NO), the judgment module 152 counts the mistypings and transmits the notification that prompts the user to re-enter the ID or the password to the IoT device 100. The display module 160 displays the notification (Step S36). The process of the above-mentioned steps S31 to S36 is repeated. If the judgment module 152 judges that the mistypings more than predetermined times are counted, the system for monitoring an IoT device 1 performs the above-mentioned IoT device monitoring process.

On the other hand, in Step S35, if the login data is correct (Step S35, YES), the judgment module 152 transmits the second input screen to the IoT device 100. The display module 160 displays the second input screen (Step S37).

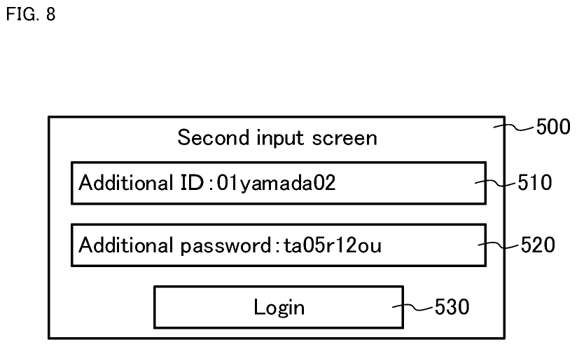

The second input screen that the display module 160 displays is described below with reference to FIG. 8. FIG. 8 shows an example of the second input screen. The display module 160 displays an additional ID input area 510, an additional password input area 520, and a login icon 530 in the second input screen 500. The additional ID input area 510 receives an input from the user to input the ID set in the process of the above-mentioned step S15. The additional password input area 520 receives an input from the user to input the password set in the process of the above-mentioned step S15. The additional ID input area 510 and the additional password input area 520 may display a virtual keyboard and receive the input from the user through this virtual keyboard or speech input, etc. The login icon 530 receives the input from the user. The data transceiving module 151 transmits the received additional ID or password to the targeted IoT device 100 as the login data.

The display module 160 receives an input of the additional ID or password. (Step S38). In Step S38, the display module 160 receives an input of the newly set original ID or password. In an embodiment, the display module 160 receives an input of “01yamada02” as the additional ID and “ta05r12ou” as the additional password.

The display module 160 judges whether the input has been completed (Step S39). In Step S39, the display module 160 judges whether the display module 160 has received an input from the login icon 530.

In Step S39, if the display module 160 judges that the input has not been completed (Step S39, NO), specifically if the display module 160 has not received an input from the login icon 530, the display module 160 repeats the process.

On the other hand, in Step S39, if the display module 160 judges that the input has been completed (Step S39, YES), specifically if the display module 160 has received an input from the login icon 530, the data transceiving module 151 transmits the received additional ID or password to the target IoT device 100 as the login data (Step S40).

The data transceiving module 151 receives the login data. The judgment module 152 judges whether the received login data is correct (Step S41). The step S41 is processed in the same way as the above-mentioned step S35. In Step S41, if the login data is not correct (Step S41, NO), the judgment module 152 counts the mistypings and transmits the notification that prompts the user to re-enter the ID or the password to the IoT device 100. The display module 160 displays the notification (Step S42). The process of the above-mentioned steps S37 to S42 is repeated. If the judgment module 152 judges that the mistypings more than predetermined times are counted, the system for monitoring an IoT device 1 performs the above-mentioned IoT device monitoring process.

On the other hand, in Step S41, if the login data is correct (Step S41 YES), the login module 153 logs in the target IoT device 100 (Step S43).

In the above-mentioned embodiment, the original ID or password is input from the first input screen, and the newly set ID or password is input from the second input screen. However, the newly set ID or password may be input from the first input screen, and the original ID or password may be input from the second input screen. In an embodiment, the new ID or password may be input before or after the login screen of the IoT device 100.

To achieve the means and the functions that are described above, a computer (including a CPU, an information processor, and various terminals) reads and executes a predetermined program. For example, the program may be provided through Software as a Service (SaaS), specifically, from a computer through a network or may be provided in the form recorded in a computer-readable medium such as a flexible disk, CD (e.g., CD-ROM), or DVD (e.g., DVD-ROM, DVD-RAM). In this case, a computer reads a program from the record medium, forwards and stores the program to and in an internal or an external storage, and executes it. The program may be previously recorded in, for example, a storage (record medium) such as a magnetic disk, an optical disk, or a magnetic optical disk and provided from the storage to a computer through a communication line.

The embodiments of the present disclosure are described above. However, the present disclosure is not limited to the above-mentioned embodiments. The effect described in the embodiments of the present disclosure is only the most preferable effect produced from the present disclosure. The effects of the present disclosure are not limited to those described in the embodiments of the present disclosure.

### DESCRIPTION OF REFERENCE NUMERALS

1 System for monitoring an IoT device
10 Computer
100 IoT device

1. A computer system, configured to monitor a connected IoT device, comprising:
a monitoring unit configured to monitor a login state of the IoT device;
a detection unit configured to detect unauthorized access based on a result of the monitoring;
a learning unit configured to learn at least one of an ID or a password for the unauthorized access;
a judgment unit configured to judge whether at least one of an ID or a password that are previously stored for the IoT device are easily decrypted by access to the IoT device; and
a priority access unit configured to control the access to an IoT device for the judgment in a predetermined priority order;
wherein the monitoring unit is configured to count accesses from outside to the IoT device, and the priority access unit is configured to control a priority order to raise a priority of an IoT device that receives more accesses from outside and access the IoT device.

2. (canceled)

3. The computer system according to claim 1, wherein the monitoring unit is configured to store an IP address that has accessed to the IoT device, and the priority access unit is configured to control a priority order to raise a priority of an IoT device accessed from a new IP address that does not exist in the stored IP addresses and access the IoT device.

4. The computer system according to claim 1, further comprising a setting unit, wherein the setting unit is configured to, if the stored password is easily decrypted, set a new password for the IoT device besides the password previously stored for the IoT device.

5. The computer system according to claim 4, wherein the setting unit is configured to set a new ID for the IoT device besides the ID previously stored for the IoT device in addition to a new password.

6. The computer system according to claim 4, further comprising a receiving unit, wherein the receiving unit is configured to, when the new password is set, receive an input of a new password before or after the login screen of the IoT device.

7. A method for monitoring an IoT device, performed by a computer system that monitors a connected IoT device, comprising:
monitoring a login state of the IoT device;
detecting unauthorized access based on a result of the monitoring;
learning at least one of an ID or a password for the unauthorized access;
judging whether at least one of an ID or a password that are previously stored for the IoT device are easily decrypted by access to the IoT device; and
accessing an IoT device accessed for the judgment in a predetermined priority order;
wherein the monitoring unit is configured to count accesses from outside to the IoT device, and the priority access unit is configured to control a priority order to raise a priority of an IoT device that receives more accesses from outside and access the IoT device;
wherein the monitoring unit is configured to count accesses from outside to the IoT device, and the priority access unit is configured to control a priority order to raise a priority of an IoT device that receives more accesses from outside and access the IoT device.

8. A computer readable program for causing a computer system that monitors a connected IoT device to execute the steps of:
monitoring a login state of the IoT device;
detecting unauthorized access based on a result of the monitoring;
learning at least one of an ID or a password for the unauthorized access;
judging whether at least one of an ID or a password that are previously stored for the IoT device are easily decrypted by access to the IoT device; and
accessing an IoT device accessed for the judgment in a predetermined priority order; wherein the monitoring unit is configured to count accesses from outside to the IoT device, and the priority access unit is configured to control a priority order to raise a priority of an IoT device that receives more accesses from outside and access the IoT device.
